(19) United States
(12) Patent Application Publication
(10) Pub. No.: US 2010/0328950 A1
(43) Pub. Date: Dec. 30, 2010

(54) ILLUMINATION DEVICE

(75) Inventors: CHIH-MING LAI, Chu-Nan (TW); YU-PIN LIU, Chu-Nan (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXSEMICON INTEGRATED TECHNOLOGY, INC., Chu-Nan (TW)

(21) Appl. No.: 12/721,511

(22) Filed: Mar. 10, 2010

(30) Foreign Application Priority Data
Jun. 26, 2009 (CN) 200910303725.7

(51) Int. Cl. F21S 4/00

(52) U.S. Cl. 362/249.02; 362/373

(57) ABSTRACT

An illumination device includes a light source and a heat-dissipation device. The heat-dissipation device has an air impeller configured for dissipating heat from the light source, and a hollow shell. The hollow shell has an inlet and an outlet with a height difference therebetween. The air impeller is removably installed on the shell between the inlet and outlet. The air impeller is adjacent to the outlet and accelerates airflow therefrom. Air pressure around the outlet is reduced and a pressure difference between the inside and outside of the hollow shell is generated. Air in hollow shell is heated by the light source and leaves the hollow shell via the outlet. Cold air enters the hollow shell via the inlet.

### BACKGROUND

1. Technical Field

The disclosure relates generally to illumination, and more particularly to an illumination device with high heat-dissipation efficiency.

2. Description of the Related Art

In general, an LED-based illumination device employs a heat-dissipation module, such as a fan, to dissipate heat generated by the LED. However, the fan is often fixed on the heat-dissipation module, making removal, cleaning, and maintenance difficult. If the fan fails, the LED can easily overheat, with shortened lifetime rapidly occurring. Thus, what is called for is an illumination device utilizing a heat dissipation system that can alleviate the limitations described.

### BRIEF DESCRIPTION OF THE DRAWINGS

FIG. 1 is a perspective view of an illumination device in accordance with a first embodiment of the disclosure.

FIG. 2 is an exploded view of the illumination device in FIG. 1.

FIG. 3 is a cross-section of an illumination device in accordance with a second embodiment of the disclosure.

FIG. 4 is a cross-section of an illumination device in accordance with a third embodiment of the disclosure.

FIG. 5 is a cross-section of an illumination device in accordance with a fourth embodiment of the disclosure.

### DETAILED DESCRIPTION

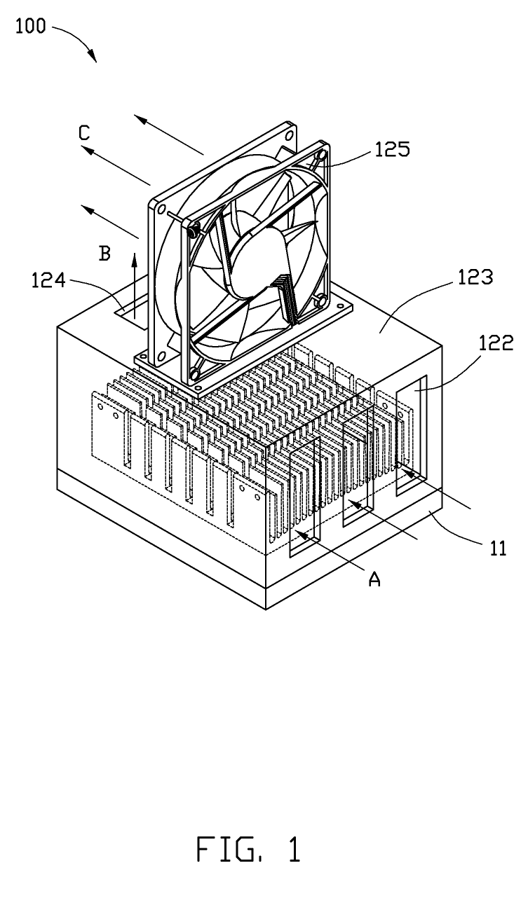

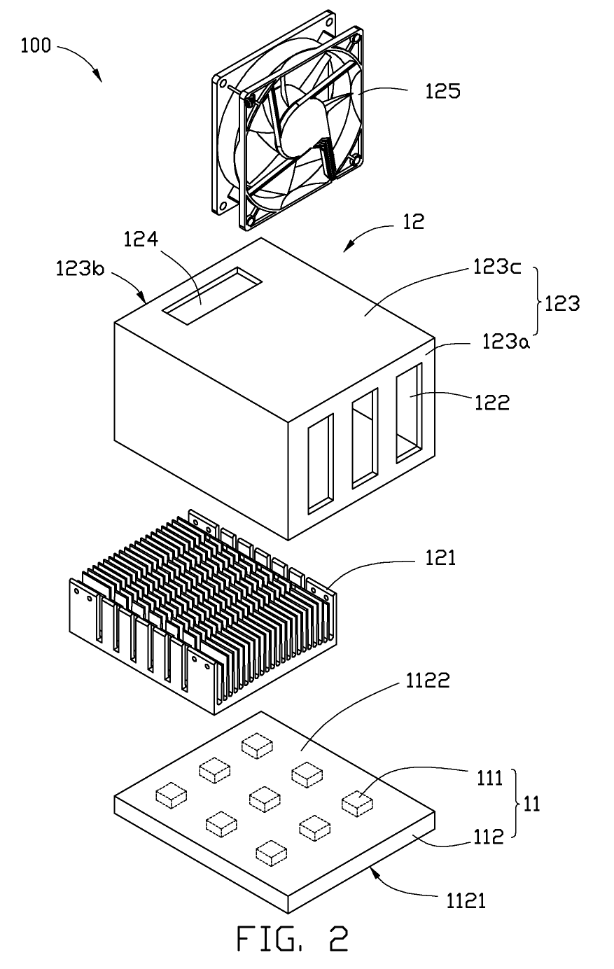

Referring to FIG. 1 and FIG. 2, an illumination device 100 in accordance with a first embodiment of the disclosure includes a light source 11 and a heat-dissipation device 12.

The light source 11 includes a plurality of light emitting diodes (LEDs) 111 and a substrate 112. The substrate 112 includes a first surface 1121 and a second surface 1122. The second surface 1122 is opposite to the first surface 1121. The LEDs 111 are mounted on the first surface 1121, and electrically connected to the substrate 112. The first surface 1121 faces away from the heat-dissipation device 12.

The heat-dissipation device 12, mounted on the second surface 1122 and thermally connected to the substrate 112, includes a plurality of cooling fins 121, a hollow shell 123, and an air impeller 125, such as fan.

The cooling fins 121 are received in the hollow shell 123.

The hollow shell 123 includes a first side surface 123a, a second side surface 123b, and an upper surface 123c. The second side surface 123b is opposite to the first side surface 123a. The upper surface 123c is adjacent to the first side surface 123a and the second side surface 123b. At least one inlet 122 is defined in the first side surface 123a and at least one outlet 124 in the upper surface 123c. Optimally, the at least one outlet 124 is located on the upper surface 123c, configured away from the first side surface 123a, and adjacent to the second side surface 123b.

When the hollow shell 123 is in normal use, the upper surface 123c is higher than the first side surface 123a and the second surface 123b.

The air impeller 125 is located on the upper surface 123c, and out of the hollow shell 123. Optimally, the air impeller 125 is located between the inlet 122 and the outlet 124, and adjacent to the outlet 124. In the first embodiment, the air impeller 125 is a fan mounted on the upper surface 123c by screws or mounting rabbets.

When the heat generated by the LEDs 111 is dissipated into the air via the cooling fins 121, the air temperature in the hollow shell 123 increases. The hot air rises to leave the hollow shell 123 through the outlet 124, generating a convection loop. Further, the air impeller 125 accelerates the airflow around the outlet 124. According to the Bernoulli principle, when the velocity of the air is increased, air pressure decreases; and when the velocity of the air is decreased, the air pressure is increased. Because there is a pressure difference, the air flows from high pressure to low pressure areas, and accordingly, the convection loop between the inside and outside of the hollow shell 123 is accelerated so as to exhaust the hot air from the hollow shell 123.

The airflow direction C generated by the air impeller 125 is perpendicular to the airflow direction B generated by the heated air through the outlet 124. The air impeller 125 exhausts the hot air along the airflow direction C. Cold air enters the hollow shell 123 via the inlet 122. This shows that the air convection loop generated by the air impeller 125 accelerates the air circulation in the hollow shell 123 so as to dissipate the heat generated by the light source 11 more efficiently.

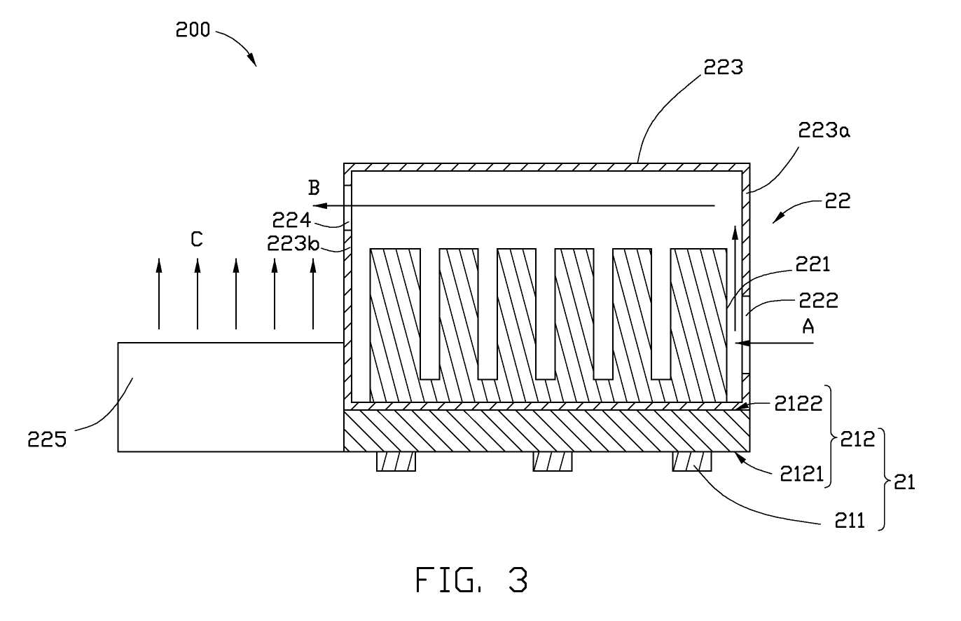

Referring to FIG. 3, the illumination device 200 in accordance with a second embodiment of the disclosure includes a light source 21 and a heat-dissipation device 22.

The light source 21 includes a plurality of LEDs 211 and a substrate 212. The substrate 212 includes a first surface 2121 and a second surface 2122. The second surface 2122 is opposite to the first surface 2121. The LEDs 211 are mounted on the first surface 2121, and electrically connected to the substrate 212.

The heat-dissipation device 22 is located on the second surface 2122, and thermally connected to the substrate 212. The heat-dissipation device 22 includes a plurality of cooling fins 221, a hollow shell 223, and an air impeller 225, such as a fan.

The cooling fins 221 are received in the hollow shell 223.

The hollow shell 223 includes a first side surface 223a and a second side surface 223b. The second surface 223b is opposite to the first side surface 223a. At least one inlet 222 is located on the first side surface 223a; and at least one outlet 224 on the second side surface 223b. Further, the location of the at least one outlet 224 is higher than the location of the at least one inlet 222. The air impeller 225 is located on the second side surface 223b, and located below the outlet 224. The airflow direction C generated by air impeller 225 is perpendicular to the airflow direction B of the heated air through the outlet 224.

The air impeller 225 exhausts the hot air along the airflow direction C thereof to effectively reduce air pressure in the hollow shell 223. The cold air flows into the hollow shell 223 through the inlet 222, and the convection loop is generated.

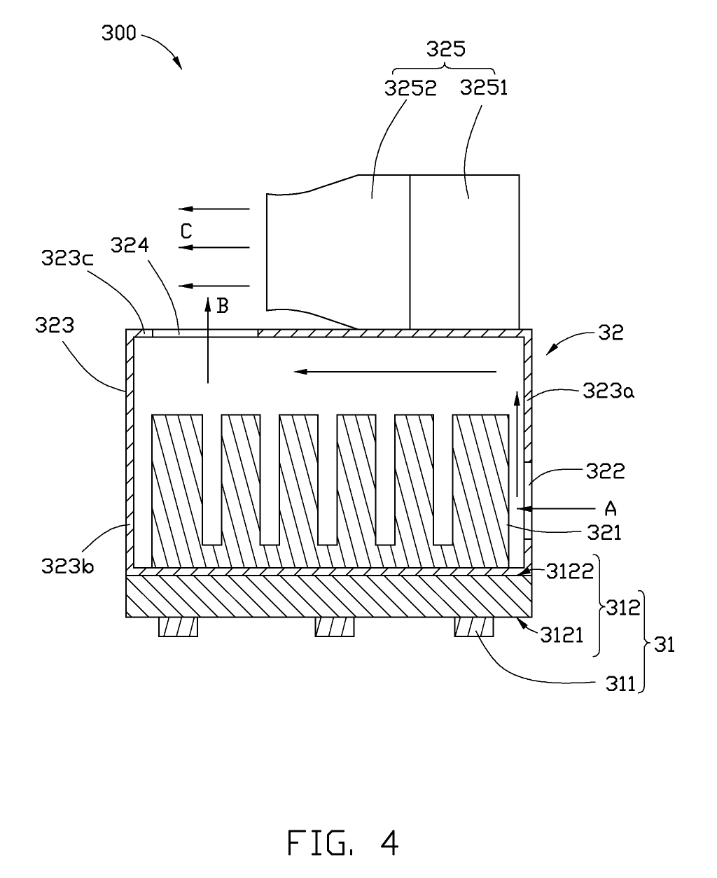

Referring to FIG. 4, the illumination device 300 in accordance with a third embodiment of the disclosure, includes a light source 31 and a heat-dissipation device 32.

The light source 31 includes a plurality of LEDs 311 and a substrate 312. The substrate 312 includes a first surface 3121 and a second surface 3122. The second surface 3122 is opposite to the first surface 3121. The LEDs 311 are mounted on the first surface 3121, and electrically connected to the substrate 312.

The heat-dissipation device 32 is located on the second surface 3122, and thermally connected to the substrate 312. The heat-dissipation device 32 includes a plurality of cooling fins 321, a hollow shell 323, and an air impeller 325, such as a fan.

The cooling fins 321 are received in the hollow shell 323.

The hollow shell 323 includes a first side surface 323a, a second side surface 323b, and an upper surface 323c. The second side surface 323b is opposite to the first side surface 323a. The upper surface 323c is adjacent to the first side surface and the second surface 323b. At least one inlet 322 is located on the first side surface 323a; and at least one outlet 324 on the upper surface 323c. Optimally, the outlet 324 is located on the upper surface 323c, away from the first side surface 323a, and adjacent to the second side surface 323b. In normal use, the upper surface 323c is higher than the first surface 323a and the second surface 323b.

The air impeller 325 includes a fan 3251 and an air-nozzle 3252. The end of the air-nozzle 3252 adjacent to the outlet 324 is rectangular, and with a small cross-section area. The end of the air-nozzle 3252 which is adjacent to fan 3251 is columnar, conical, and with a large cross-section. The shape is recognized as providing optimum compression of air flowing therethrough, increasing the pressure difference between the inside and outside of the hollow shell 323. Thus the heat-dissipation efficiency of the illumination device 300 is increased effectively. The fan 3251 is received in the air-nozzle 3252.

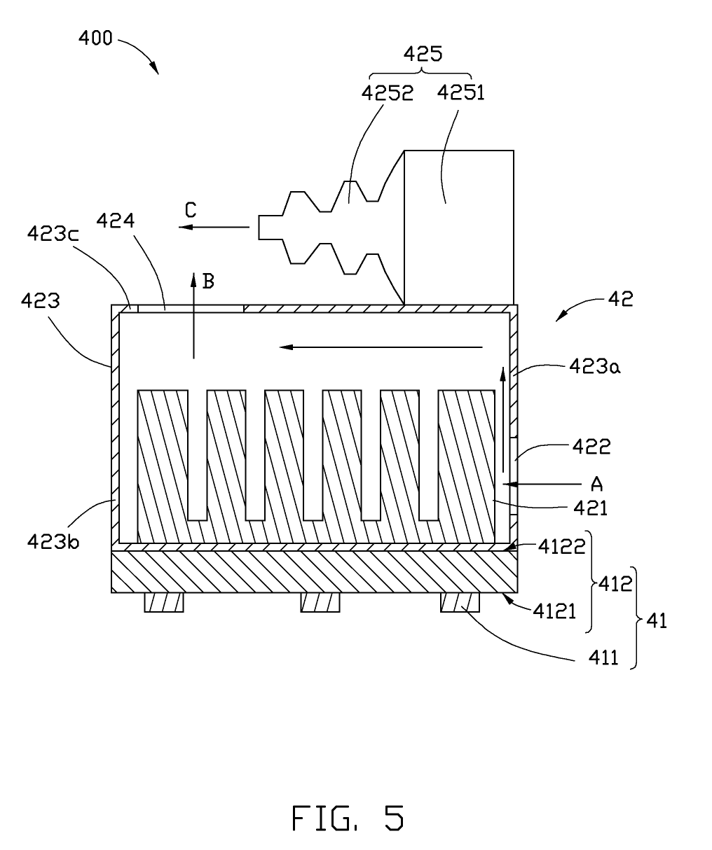

Referring to FIG. 5, the illumination device 400 in accordance with a fourth embodiment of disclosure includes a light source 41 and a heat-dissipation device 42.

The light source 41 includes a plurality of LEDs 411 and a substrate 412. The substrate 412 includes a first surface 4121 and a second surface 4122. The second surface 4122 is opposite to the first surface 4121. The LEDs 411 are mounted on the first surface 4121, and electrically connected to the substrate 412.

The heat-dissipation device 42 is located on the second surface 4122, and thermally connected to the substrate 412. The heat-dissipation device 42 includes a plurality of cooling fins 421, a hollow shell 423, and an air impeller 425, such as a fan.

The cooling fins 421 are received in the hollow shell 423.

The hollow shell 423 includes a first side surface 423a, a second side surface 423b, and an upper surface 423c. The second side surface 423b is opposite to the first side surface 423a. The upper surface 423c is adjacent to the first side surface 423a and the second side surface 423b. Furthermore, at least one inlet 422 is located on the first side surface 423a and at least one outlet 424 on the upper surface 423c.

Optimally, the at least one outlet 424 is located on the upper surface 423c, away from the first side surface 423a, and adjacent to the second side surface 423b. In normal use, the upper surface 423c is higher than the first side surface 423a and the second surface 423b.

The air impeller 425 includes a fan 4251 and a bellow-shaped air-nozzle 4252 configured for housing the fan 4251. The air-nozzle has a gradually decreased diameter toward the outlet 424. The bellow-shaped air-nozzle 4252 accelerates airflow therethrough, increasing pressure difference between the inside and outside of hollow shell 423. The heat-dissipation efficiency of illumination device 400 is improved accordingly.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illumination device comprising:
a light source comprising a substrate comprising a first surface and a second surface, and at least one light emitting diode mounted on the first surface of the substrate; and
a heat-dissipation device located over the second surface of the substrate and comprising a hollow shell comprising at least one inlet and at least one outlet having a height difference, and an air impeller removably installed on the hollow shell, located out of the hollow shell, and configured for dissipating heat generated by the light source, air in the hollow shell being heated by the light source to leave the hollow shell via the at least one outlet, the air impeller generating an airflow blowing to the heated air through the at least one outlet, cold air entering the hollow shell via the at least one inlet.

2. The illumination device as claimed in claim 1, wherein the heat-dissipation device further comprises a plurality of cooling fins located in the hollow shell.

3. The illumination device as claimed in claim 1, wherein the opening direction of the inlet is parallel to the opening direction of the outlet; and the opening location of the outlet is higher than the opening location of the inlet.

4. The illumination device as claimed in claim 1, wherein the opening direction of the inlet is perpendicular to the opening direction of the outlet.

5. The illumination device as claimed in claim 1, wherein the hollow shell comprises an upper surface and a side surface adjacent to the upper surface, the inlet located on the side surface, the outlet located on the upper surface, the upper surface higher than the side surface adjacent to the upper surface, and the air impeller installed on the upper surface of the hollow shell.

6. The illumination device as claimed in claim 1, wherein the hollow shell comprises an upper surface and a first side surface and a second surface adjacent to the upper surface, the inlet located on the first side surface, the outlet located on the second surface, and the location of the inlet on the first surface being lower than the location of the outlet on the second surface.

7. The illumination device as claimed in claim 1, wherein the air impeller comprises a fan.

8. The illumination device as claimed in claim 1, wherein the air impeller comprises a fan and an air-nozzle, an end of the air-nozzle adjacent to the at least one outlet is rectangular and with a small cross-section, and an opposite end of the air-nozzle is columnar, conical, and with a large cross-section.

9. The illumination device as claimed in claim 1, wherein the air-nozzle is bellow-shaped whit a diameter reduced toward the at least one outlet.

10. The illumination device as claimed in claim 1, wherein the fan is housed in the air-nozzle.
